(19) United States
(12) Patent Application Publication
(10) Pub. No.: US 2026/0195773 A1
(43) Pub. Date: Jul. 9, 2026

(54) AUTONOMOUS GOVERNANCE LAYER FOR HYBRID HUMAN AI ORGANIZATIONS

(71) Applicant: George William Bickerstaff, III, Greenwich, CT (US)

(72) Inventor: George William Bickerstaff, III, Greenwich, CT (US)

(21) Appl. No.: 19/452,420

(22) Filed: Jan. 19, 2026

(51) Int. Cl. G06Q 30/018; H04L 9/40

(52) U.S. Cl. CPC G06Q 30/018; H04L 63/20

(57) ABSTRACT

An autonomous governance layer for hybrid human-AI organizations enables humans and artificial intelligence agents to co-govern organizational actions using trust-weighted voting, automated policy enforcement, rollback on violation, and immutable outcome recording. The system provides a neutral, auditable governance substrate applicable to hospitals, corporations, decentralized organizations, and regulated infrastructures.

### TECHNICAL FIELD

The present invention relates to computer-implemented governance systems for organizations comprising both human participants and artificial intelligence agents.

More particularly, the invention relates to systems and methods for autonomous, trust-weighted governance in which humans and approved AI agents jointly participate in decision-making, policy enforcement, and organizational control using cryptographically verifiable voting, automatic rollback mechanisms, and immutable outcome recording.

### BACKGROUND

Modern organizations increasingly rely on artificial intelligence systems to make or recommend operational, financial, clinical, and strategic decisions.

Existing organizational governance frameworks are designed primarily for human decision-makers and are ill-suited to incorporate autonomous or semi-autonomous AI agents as first-class governance participants.

As a result, AI systems often operate outside formal governance structures, creating gaps in accountability, auditability, and control.

Decentralized governance mechanisms such as voting systems exist, but they typically lack dynamic trust weighting, automated enforcement, and rollback capabilities necessary for regulated or safety-critical environments.

In hybrid human-AI organizations, failures in governance can result in regulatory violations, financial loss, safety incidents, or erosion of stakeholder trust.

Current approaches do not provide a unified protocol for co-governance by humans and AI agents with enforceable policies, automatic remediation, and durable audit trails.

Accordingly, there exists a need for an autonomous governance layer that enables hybrid human-AI organizations to operate under transparent, enforceable, and adaptive governance rules.

### SUMMARY OF THE INVENTION

The disclosed invention provides an autonomous governance layer for hybrid human-AI organizations.

A governance participation engine registers human stakeholders and approved AI agents as governance participants with associated trust weights.

A trust-weighted voting engine executes governance decisions by aggregating votes from participants according to dynamically computed trust scores.

A policy enforcement and rollback engine monitors decisions and actions for violations and automatically reverts actions when governance constraints are breached.

An immutable governance ledger records votes, decisions, enforcement actions, and outcomes to provide a durable audit trail.

### Definitions

Activation Token: A cryptographic artifact authorizing a human or AI agent to participate in governance actions.

Governance Action: Any organizational decision, policy change, execution command, or operational authorization subject to governance.

Governance Ledger: An immutable data structure recording governance events, votes, decisions, and enforcement outcomes.

Governance Participant: A human stakeholder or approved artificial intelligence agent authorized to participate in governance.

Policy Constraint: A machine-readable rule defining permitted or prohibited governance actions.

Rollback Event: An automated reversal of a governance action triggered by a detected policy violation.

Trust Score: A normalized value representing credibility, reliability, or authority of a governance participant.

Trust-Weighted Voye: A governance vote scaled according to a participant's trust score.

Violation Detector: A system component that detects breaches of policy constraints.

Voting Outcome: The finalized result of a governance vote after trust weighting and policy validation.

### BRIEF DESCRIPTION OF THE DRAWINGS

FIG. 1 Illustrates an Autonomous Governance System Architecture for hybrid human-AI organizations.

FIG. 2 Illustrates Governance Participant Registration and Trust assignment.

FIG. 3 illustrates trust-weighted voting and decision execution.

FIG. 4 illustrates policy enforcement, violation detection, and rollback.

FIG. 5 illustrates organizational applications across corporate, clinical, and decentralized environments.

### DETAILED DESCRIPTION

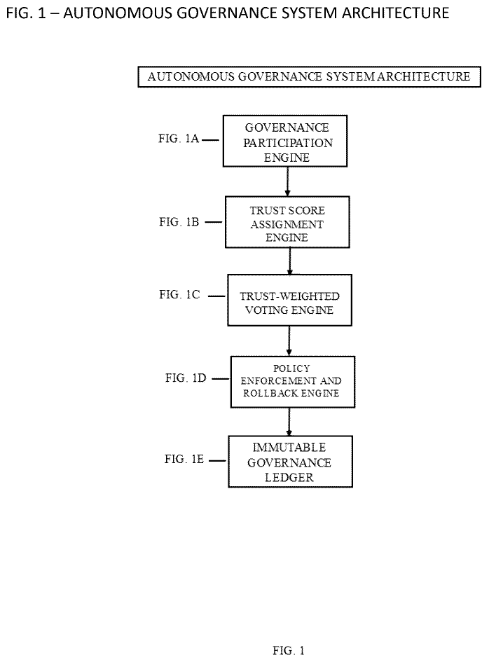

### FIG. 1—Autonomous Governance System

FIG. 1 illustrates a system architecture comprising a governance participation engine, a trust-weighted voting engine, a policy enforcement and rollback engine, and an immutable governance ledger. The architecture enables humans and AI agents to co-govern organizational actions using a unified protocol. All governance events are cryptographically verifiable and auditable.

### FIG. 1A—Governance Participation Engine

FIG. 1A illustrates registration of governance participants including human stakeholders and approved AI agents. Each participant is associated with identity credentials and activation tokens. Participation rights are explicitly defined and revocable.

### FIG. 1B—Trust Score Assignment Engine

FIG. 1B illustrates computation and assignment of trust scores to governance participants. Trust scores may reflect role, historical performance, compliance behavior, or outcome quality. Scores are periodically recalculated.

### FIG. 1C—Trust-Weighted Voting Engine

FIG. 1C illustrates execution of governance votes weighted by trust scores. Votes from higher-trust participants exert proportionally greater influence. Aggregation produces a deterministic voting outcome.

### FIG. 1D—Policy Enforcement and Rollback Engine

FIG. 1D illustrates enforcement of policy constraints during and after governance actions. The engine monitors actions for violations and automatically triggers rollback events when constraints are breached. Safety and compliance are enforced without human intervention.

### FIG. 1E—Immutable Governance Ledger

FIG. 1E illustrates recording of governance events in an immutable ledger. Votes, outcomes, and enforcement actions are permanently stored. The ledger supports audit, compliance, and dispute resolution.

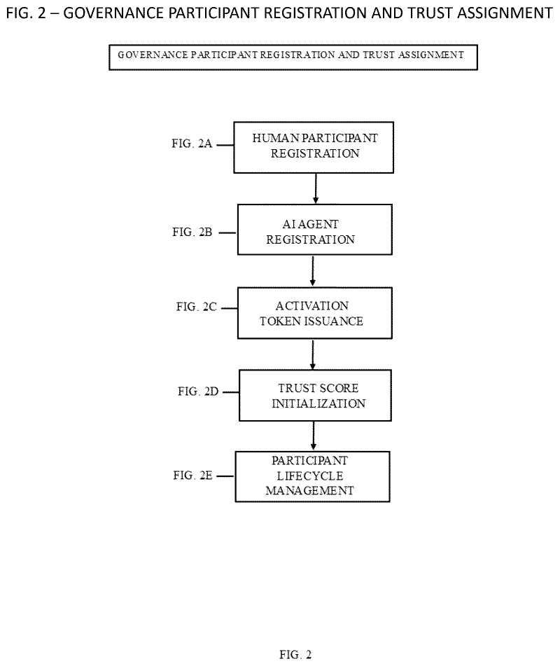

### FIG. 2—Governance Participant Registration and Trust Assignment

FIG. 2 illustrates onboarding and lifecycle management of governance participants. Human and AI participants are treated as first-class entities. Governance integrity is preserved.

### FIG. 2A—Human Participant Registration

FIG. 2A illustrates registration of human stakeholders using identity verification and role assignment. Permissions are scoped by organizational policy. Accountability is explicit.

### FIG. 2B—AI Agent Registration

FIG. 2B illustrates registration of AI agents as governance participants. Each AI agent is bound to a specific function and operational scope. Unapproved autonomy is prevented.

### FIG. 2C—Activation Token Issuance

FIG. 2C illustrates issuance of activation tokens enabling governance participation. Tokens may be time-limited or purpose-bound. Revocation is supported.

### FIG. 2D—Trust Score Initialization

FIG. 2D illustrates initialization of trust scores for new participants. Initial scores reflect role and credentials. Scores evolve over time.

### FIG. 2E—Participant Lifecycle Management

FIG. 2E illustrates ongoing management of participant status, trust score updates, and revocation. Governance adapts to organizational change. Risk is controlled.

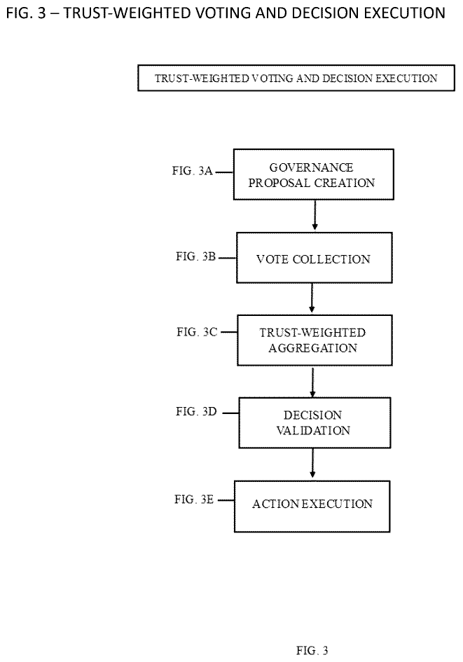

### FIG. 3—Trust-Weighted Voting and Decision Execution

FIG. 3 illustrates execution of governance decisions through trust-weighted voting. Decision logic is transparent and deterministic. Execution follows validated outcomes.

### FIG. 3A—Governance Proposal Creation

FIG. 3A illustrates creation of governance proposals. Proposals define actions, scope, and constraints. Participants understand implications.

### FIG. 3B—Vote Collection

FIG. 3B illustrates collection of votes from human and AI participants. Votes are authenticated and timestamped. Replay is prevented.

### FIG. 3C—Trust-Weighted Aggregation

FIG. 3C illustrates aggregation of votes using trust weighting. Influence reflects credibility and responsibility. Minority protection may be enforced.

### FIG. 3D—Decision Validation

FIG. 3D illustrates validation of voting outcomes against policy constraints. Invalid outcomes are rejected. Governance integrity is preserved.

### FIG. 3E—Action Execution

FIG. 3E illustrates execution of approved governance actions. Execution is logged and monitored. Actions remain reversible.

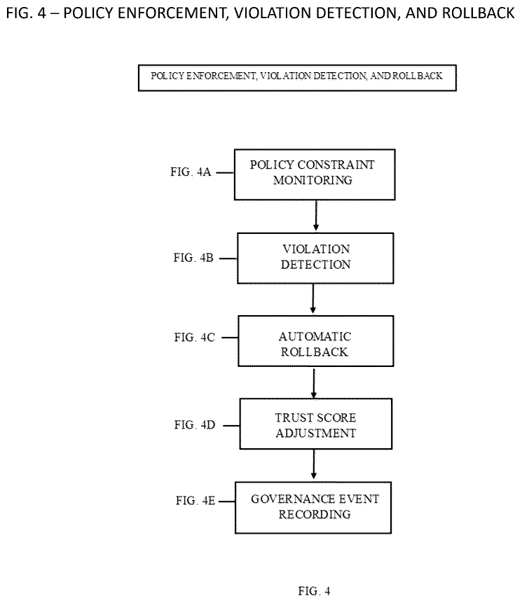

### FIG. 4—Policy Enforcement, Violation Detention, and Rollback

FIG. 4 illustrates continuous enforcement of governance constraints. Violations are detected and remediated automatically. Organizational safety is maintained.

### FIG. 4A—Policy Constraint Monitoring

FIG. 4A illustrates monitoring of executed actions against policy constraints. Monitoring is continuous and automated. Latent violations are detected.

### FIG. 4B—Violation Detention

FIG. 4B illustrates detection of governance violations. Violations may involve scope breaches, unsafe actions, or regulatory noncompliance. Detection triggers remediation.

### FIG. 4C—Automatic Rollback

FIG. 4C illustrates automatic rollback of violating actions. Systems are restored to a safe prior state. Downtime and damage are minimized.

### FIG. 4D—Trust Score Adjustment

FIG. 4D illustrates adjustment of trust scores following violations. Accountability is enforced. Future influence is recalibrated.

### FIG. 4E—Governance Event Recording

FIG. 4E illustrates recording of enforcement and rollback events in the governance ledger. Evidence is preserved. Oversight is enabled.

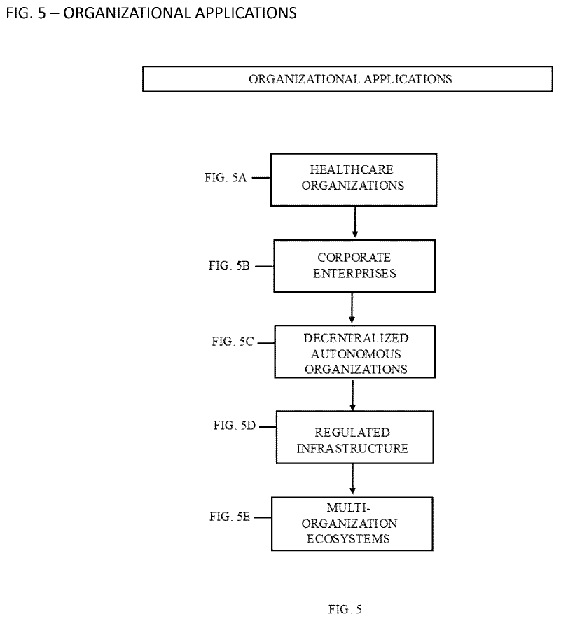

### FIG. 5—Organizational Applications

FIG. 5 illustrates application of the governance layer across organizational types. The protocol is domain-agnostic. Governance scales.

### FIG. 5A—Healthcare Organizations

FIG. 5A illustrates use in hospitals where clinicians and AI systems co-govern clinical protocols. Safety constraints are enforced. Auditability is guaranteed.

### FIG. 5B—Corporate Enterprises

FIG. 5B illustrates use in corporations where executives and AI agents co-govern operations. Risk and compliance are controlled. Transparency improves.

### FIG. 5C—Decentralized Autonomous Organizations

FIG. 5C illustrates use in DAOs with trust-weighted governance. Sybil resistance is enhanced. Governance stability increases.

### FIG. 5D—Regulated Infrastructure

FIG. 5D illustrates use in regulated infrastructure such as utilities or transportation. Automated rollback prevents catastrophic failure. Compliance is continuous.

### FIG. 5E—Multi-Organization Ecosystems

FIG. 5E illustrates governance across federated organizations. Shared control is auditable. Neutral governance is achieved.

### EXAMPLE

In one example, a hospital system deploys an autonomous governance layer to manage clinical decision protocols involving both physicians and AI diagnostic agents. Physicians and AI agents are registered as governance participants with trust scores reflecting credentials, performance, and compliance history.

When a protocol change is proposed, both humans and AI agents vote, with influence weighted by trust. The approved change is executed automatically, monitored for compliance, and recorded in the governance ledger.

If the AI agent later initiates an action that violates safety policy, the system automatically rolls back the action, reduces the agent's trust score, and records the event for regulatory review, thereby preserving patient safety and organizational accountability.

1. A computer-implemented system for autonomous governance of a hybrid human-AI organization, comprising:
a governance participation engine configured to register human participants and artificial intelligence agents as governance participants;
a trust-weighted voting engine configured to aggregate governance votes based on trust scores;
a policy enforcement and rollback engine configured to detect violations and automatically reverse governance actions; and
an immutable governance ledger configured to record governance events and outcomes.

2. A computer-implemented method for autonomous governance in a hybrid human-AI organization, comprising:
registering human participants and artificial intelligence agents as governance participants;
assigning trust scores to the governance participants;
executing governance votes weighted by trust scores;
enforcing policy constraints on governance actions; and
automatically rolling back actions upon detection of violations.

3. A non-transitory computer-readable medium storing instructions that, when executed by one or more processors, cause performance of operations comprising:
registering governance participants;
executing trust-weighted voting;
enforcing governance policies; and
recording governance outcomes in an immutable ledger.

4. The system of claim 1, wherein the governance participants include both human stakeholders and artificial intelligence agents.

5. The system of claim 1, wherein trust scores are dynamically adjusted based on governance outcomes.

6. The system of claim 1, wherein rollback events are triggered automatically without human intervention.

7. The system of claim 1, wherein the immutable governance ledger is implemented using a distributed ledger.

8. The system of claim 1, wherein governance actions include operational, financial, or clinical decisions.

9. The method of claim 2, further comprising issuing activation tokens to authorize governance participation.

10. The system of claim 1, wherein policy constraints include safety, regulatory, or ethical requirements.
